(19) United States
(12) Patent Application Publication
(10) Pub. No.: US 2026/0077940 A1
(43) Pub. Date: Mar. 19, 2026

(54) Packaging Insulation Liner Including Foil Paper

(71) Applicant: MP Global Products, L.L.C., Norfolk, NE (US)

(72) Inventors: Reid BORGMAN, Norfolk, NE (US); Alan B. COLLISON, Pierce, NE (US)

(73) Assignee: MP Global Products, L.L.C., Norfolk, NE (US)

(21) Appl. No.: 19/323,484

(22) Filed: Sep. 9, 2025

Related U.S. Application Data
(60) Provisional application No. 63/694,543, filed on Sep. 13, 2024.

(51) Int. Cl. B65D 81/38; B32B 29/06; B65D 5/60

(52) U.S. Cl. CPC B65D 81/3858; B32B 29/06; B65D 5/60; B32B 2255/12; B32B 2255/205; B32B 2307/304; B32B 2307/718; B32B 2311/24; B32B 2311/30; B32B 2439/62

(57) ABSTRACT

A packaging insulation liner is disclosed. The packaging insulation liner is configured to be placed in a packaging container. The packaging insulation liner includes an insulation pad and a foil paper coupled to the insulation pad. The foil paper includes a paper layer and a metallic layer disposed on the paper layer. The foil paper is recyclable.

### CROSS-REFERENCE TO RELATED APPLICATIONS

This application claims the benefit of U.S. Provisional Application No. 63/694,543, filed on Sep. 13, 2024. The entire disclosure of the above application is incorporated herein by reference.

### FIELD

The present disclosure relates to a packaging insulation liner including a foil paper and a method of making the same.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Insulated packaging products (e.g., insulated boxes) are widely used in many packaging assemblies for delivery or shipping applications. An insulated packaging device is desirable when shipping materials at reduced or elevated temperatures while avoiding large temperature changes during transport. Some packaging assemblies including insulation are formed from materials that are not curbside recyclable. It is advantageous to develop a packaging assembly that includes insulation that is curbside recyclable. Moreover, it is advantageous to develop a packaging assembly having improved thermal performance that is curbside recyclable.

### SUMMARY

This section provides a general summary of the disclosure, and is not a comprehensive disclosure of its full scope or all of its features.

An example of a packaging insulation liner according to the present disclosure includes an insulation pad and a foil paper coupled to the insulation pad. The foil paper includes a paper layer and a metallic layer disposed on the paper layer. The foil paper is recyclable.

In one aspect, the insulation pad has a first surface and a second surface opposite of the first surface. The foil paper is attached to the first surface.

In one aspect, the foil paper is also attached to the second surface.

In one aspect, a first piece of the foil paper is attached to one of (i) a piece of a foil-free paper or (ii) a second piece of the foil paper to encapsulate the insulation pad.

In one aspect, the metallic layer of the foil paper is made form a metal. The metal is selected from a group consisting of aluminum, gold, tin, silver, copper, steel, lead, alloys thereof, and combinations thereof.

In one aspect, the metallic layer of the foil paper is made of a metal selected from a group consisting of aluminum, steel, or combinations thereof.

In one aspect, the insulation pad includes a plurality of fibers made from a material selected from the group consisting of thermoplastic, cellulose, and combinations thereof.

In one aspect, the plurality of fibers include substrate fibers and binder fibers. The substrate fibers are made of the material selected from the group consisting of thermoplastic, cellulose, and combinations thereof. The binder fibers are bicomponent fibers made of thermoplastic.

In one aspect, a packaging assembly includes the insulation liner and a packaging container. The insulation liner is disposed within the packaging container.

In one aspect, the packaging container is a cardboard box.

A method of making an insulation liner according to the present disclosure includes depositing a metal paper on a substrate to form a foil paper and coupling the foil paper to an insulation pad.

In one aspect, the method further includes coating the paper substrate with a varnish coating before depositing the metal on the paper substrate.

In one aspect, the method further includes applying a lacquer to the foil paper before coupling the foil paper to the insulation pad.

In one aspect, the method further includes moisturizing the foil paper before applying the lacquer to the foil paper.

Another method of making an insulation liner according to the present disclosure includes depositing a metal on a surface of a substrate to form a metal layer, laminating a paper layer onto the metallic layer of the substrate to form a foil paper, separating the foil paper from the substrate, and coupling the foil paper to an insulation pad.

In one aspect, the method further includes coating the surface of the substrate with a lacquer coating before depositing the metal on the surface of the substrate.

In one aspect, the substrate is a polyethylene film.

In one aspect, the method further includes laminating the paper layer onto the metallic layer using a wet lamination process.

In one aspect, the method further includes laminating the paper layer onto the metallic layer using a dry lamination process.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1A is an exploded perspective view of a packaging assembly including an insulation liner according to the principles of the present disclosure;

FIG. 1B is an assembled perspective view of the packaging assembly of FIG. 1A;

FIG. 2 is a perspective view of the insulation liner of FIG. 1A including an insulation pad and foil paper attached to at least one side of the insulation pad, with a portion of the foil paper peeled away from the insulation pad for illustration purposes;

FIG. 3 is a perspective view of a portion of the foil paper of FIG. 2;

FIG. 4 is a perspective view of another insulation liner including an insulation pad and foil paper attached to at least one side of the insulation pad according to the principles of the present disclosure;

FIG. 5 is an exploded perspective view of another insulation liner including an insulation pad and foil paper attached to at least one side of the insulation pad according to the principles of the present disclosure;

FIG. 6A is an exploded perspective view of another packaging assembly including another insulation liner according to the principles of the present disclosure;

FIG. 6B is an assembled perspective view of the packaging assembly of FIG. 6A;

FIG. 7 is a flowchart and schematic of a method of making a foil paper for an insulation liner according to the principles of the present disclosure;

FIG. 8A is a flowchart of another method of making a foil paper for an insulation liner according to the principles of the present disclosure;

FIG. 8B is a perspective view of a laminated foil paper made according to the method of FIG. 8A with portions of layers in the foil paper omitted and the layers peeled away from one another for illustration purposes; and

FIGS. 8C and 8D are schematics of lamination processes that may be incorporated into the method of FIG. 8A.

In the drawings, reference numbers may be reused to identify similar and/or identical elements.

### DETAILED DESCRIPTION

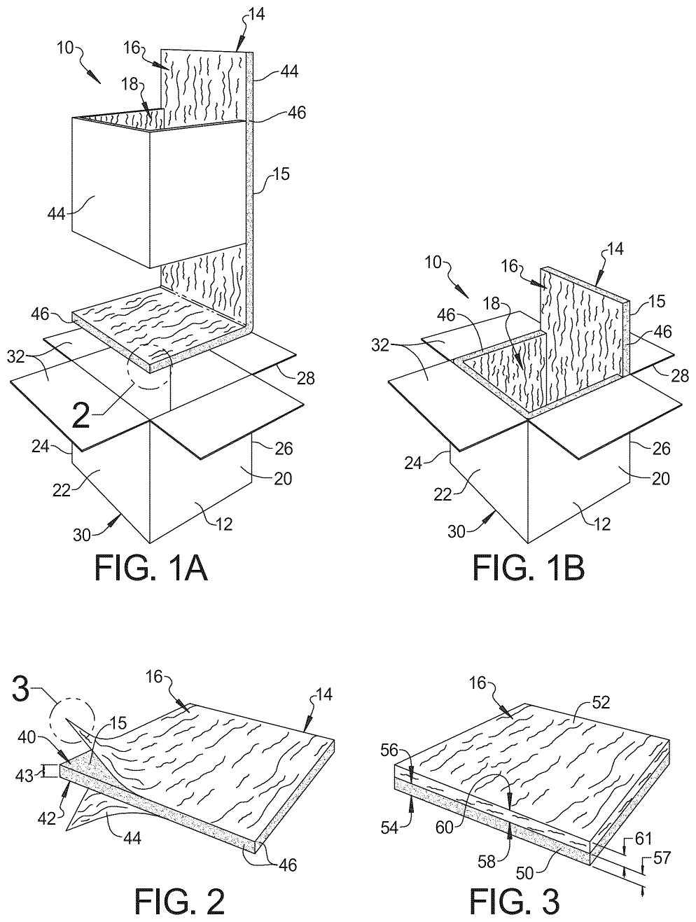

Referring now to FIGS. 1A and 1B, a packaging assembly 10 according to the principles of the present disclosure is shown. The packaging assembly 10 includes a packaging container 12 and a pair of insulation liners 14. Each insulation liner 14 includes an insulation pad 15 and a foil paper 16 attached to at least one surface of the insulation pad 15. The packaging container 12 and insulation liners 14 cooperate to define an inner compartment 18. The packaging container 12 is configured to store and transport temperature-sensitive goods (i.e., perishable goods), such as food, beverages, medical samples, pharmaceuticals, etc., disposed in the inner compartment 18. For example, the packaging container 12 may be configured to transport groceries or pre-packaged meals to a consumer. One or more cooling devices (e.g., icepacks, refrigerants, gel packs, dry ice) (not shown) may be disposed in the inner compartment 18 to refrigerate the temperature-sensitive goods.

While FIGS. 1A and 1B depict the packaging container 12 as a box (e.g., a cardboard box), it is contemplated that the packaging container 12 may be a crate, a tub, a pouch, a bag, an envelope, or any other container suitable to transport a temperature-sensitive good. The packaging container 12 may be recyclable (e.g., can be used to manufacture new products) and/or repulpable (e.g., can be re-wet and fiberized into a subsequent paper or cardboard sheet). Specifically, the packaging container 12 may be recyclable and/or repulpable in accordance with the requirements of the Aug. 16, 2013 revision of the “Voluntary Standard For Repulping and Recycling Corrugated Fiberboard Treated to Improve Its Performance in the Presence of Water and Water Vapor” provided by the Fibre Box Association of Elk Grove Village, IL. Preferably, the packaging container 12 is curbside recyclable. A material that is curbside recyclable is recyclable using equipment that is typically installed at most recycling plants. Some materials that are recyclable, such as plastic films, are not curbside recyclable because they can damage equipment found at most recycling plants, and therefore must be recycled using specialized equipment. For example, the packaging container 12 may be formed of cardboard, paper, curbside recyclable plastic, etc.

In a fully assembled state, the packaging container 12 includes a first side 20, a second side 22, a third side 24, and a fourth side 26 that are folded or joined to define the inner compartment 18. The packaging container 12 further includes a fifth side 28 and a sixth side 30 positioned to close or seal a top and bottom end of the packaging container 12, respectively. The fifth side 28 may be formed by folding a first plurality of tabs 32 extending from the upper ends of the first, second, third, and fourth sides 20, 22, 24, 26. Similarly, the sixth side 30 may be formed by folding a second plurality of tabs (not shown) extending from the lower ends of the first, second, third, and fourth sides 20, 22, 24, 26. The sides 20, 22, 24, 26, 28, 30 may be integrally formed from the same sheet of material. Additionally or alternately, all or a portion of the sides 20, 22, 24, 26, 28, 30 may be distinctly formed and subsequently joined together to form the packaging container 12.

The insulation liner 14 is a barrier that inhibits the transfer of heat between the inner compartment 18 of the packaging container 12 and the environment outside of the packaging container 12. For example, the insulation liner 14 is configured to slow the heating of the contents of the packaging container 12 by inhibiting heat from entering to the inner compartment 18 and inhibiting cold air (e.g., from the cooling device and/or the contents of the packaging container 12) from escaping.

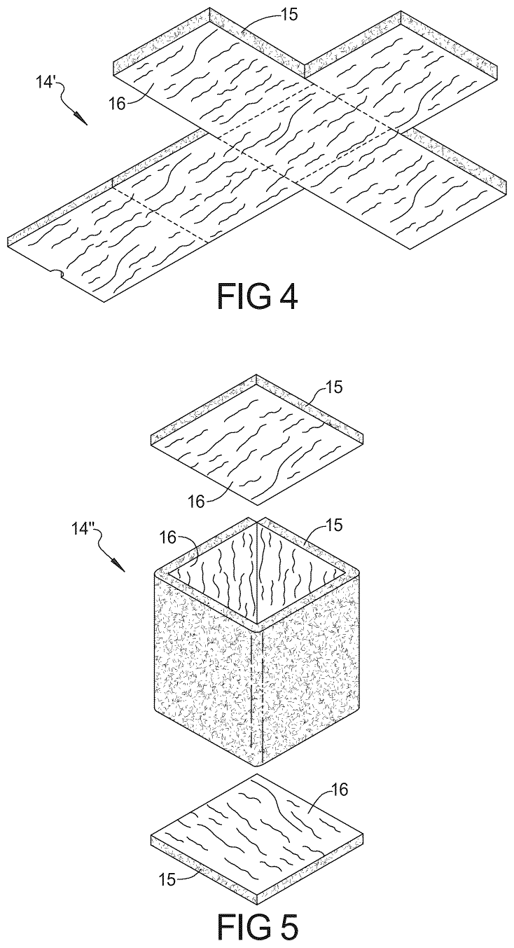

The insulation liner 14 may line all or a portion of the sides 20, 22, 24, 26, 28, 30 of the packaging container 12. In the example of FIGS. 1A and 1B, the packaging assembly 10 includes a pair of the insulation liners 14 that are joined or fitted together when the packaging assembly 10 is fully assembled. Alternatively, the insulation liner 14 may be a unitary body that is bent or folded into the shape of the packaging container 12 (see, e.g., insulation liner 14′ of FIG. 4). Alternately, the insulation liner 14 may include three or more insulation liners 14 that are joined or fitted together (see, e.g., insulation liner 14″ of FIG. 5). The shape, size, and configuration of the insulation liner 14 may be tailored to achieve the desired thermal characteristics of the packaging assembly 10.

The insulation pad 15 may be formed of any suitable insulative material. The insulation pad 15 may be recyclable and/or repulpable, such as in accordance with the requirements of the Aug. 16, 2013 revision of the “Voluntary Standard For Repulping and Recycling Corrugated Fiberboard Treated to Improve Its Performance in the Presence of Water and Water Vapor” provided by the Fibre Box Association of Elk Grove Village, IL. The insulation pad 15 may be curbside recyclable. It is also contemplated that the insulation pad 15 may be neither recyclable nor repulpable.

When the insulation pad 15 is neither recyclable nor repulpable, the insulation pad 15 may include foam insulation (e.g. expanded polystyrene, polyurethane) and/or bubble insulation (e.g., polyethylene). When the insulation pad 15 is recyclable and/or repulpable, the insulation pad 15 may include substrate fibers bound together by binder fibers. The substrate fibers and/or the binder fibers may include fibers made from a wide variety of materials such as thermoplastic (e.g., polyethylene (PE), polyethylene terephthalate (PET), polypropylene (PP), nylon, acrylic), cellulose (e.g., hemp, cotton, denim, paper, beet, banana leaf), and/or combinations thereof.

The binder fibers may be bicomponent fibers with a core and a sheath surrounding the core. The core may be made of a first material, and the sheath may be made of a second material with a lower melting point than the first material. For example, the core may be made of PP or PET, and the sheath may be made of PE or copolymerized PET (co-PET). The binder fibers may bind to one another to form a fiber matrix, and the substrate fibers may be captured within the fiber matrix to form the fiber structure. The binder fibers may make up less than or equal to 10 percent by weight of the insulation pad 15. The binder fibers may have a length that is less than or equal to 24 mm. The binder fiber composition, weight percent, and length as disclosed in this paragraph may result in the insulation pad 15 being recyclable and/or repulpable. However, it is contemplated that the insulation pad 15 may be formed with binder fibers having a different composition, weight percent, and/or length which may not necessarily be recyclable and/or repulpable.

Referring now to FIG. 2, the insulation pad 15 has a first surface 40 and an opposite second surface 42. When assembled in the packaging container 12, the first surface 40 is positioned adjacent to and/or facing the inner compartment 18 and the second surface 42 is positioned adjacent to and/or facing one of the sides 20, 22, 24, 26, 28, 30 of the packaging container 12. The second surface 42 of the insulation liner 14 may be in direct contact with one or more of the sides 20, 22, 24, 26, 28, 30 of the packaging container 12. The insulation pad 15 has a first thickness 43, which may be within a range from 0.25 inches to 3 inches. The insulation pad 15 may have a weight between 150 grams per square meter (GSM) and 3000 GSM, and its weight may depend on its thickness (e.g., higher weight for larger thickness and vice versa). The insulation pad 15 may have a density that is less than about 10 pounds per cubic foot.

The foil paper 16 is coupled to one or both of the surfaces 40, 42 of the insulation pad 15. For example, the foil paper 16 may be attached to all or a portion of the first surface 40 of the insulation pad 15. Additionally or alternately, the foil paper 16 may be attached to all or a portion of the second surface 42 of the insulation pad 15. The foil paper 16 may be directly attached to the first surface 40 and/or the second surface 42 of the insulation pad 15 using, for example, adhesive. The foil paper 16 may be attached to the first surface 40 and/or the second surface 42 of the insulation pad 15 using a lamination process.

When the foil paper 16 is attached to only one surface of the insulation pad 15 (e.g., attached to the first surface 40), a foil-free paper 44, such as kraft paper, may be attached to the opposite surface (e.g., attached to the second surface 42), and vice versa. The foil-free paper 44 may be a natural kraft paper or a bleached kraft paper. Alternately, the opposite surface may be free of a paper, exposing the insulation pad 15 (see, e.g., insulation liners 14′ and 14″ of FIGS. 4 and 5, respectively). In the configuration shown in FIG. 2, the insulation pad 15 is laminated with the foil paper 16 on the first surface 40 and the foil-free paper 44 on the second surface 42. In this way, edges 46 of the insulation liner 14 are exposed (i.e., not encapsulated).

Referring now to FIG. 3, the foil paper 16 includes a paper layer 50 and a metallic layer 52 disposed on the paper layer 50. The foil paper 16 may have a total thickness that is greater than or equal to 50 micrometers (μm) to less than or equal to 150 micrometers (μm). The foil paper 16 may have a weight that is greater than or equal to 50 GSM to less than or equal to 80 GSM, or more narrowly greater than or equal to 60 GSM to less than or equal to 70 GSM.

The paper layer 50 has a first surface 54 and a second surface 56 opposite of the first surface 54. The paper layer 50 has a second thickness 57, which may be greater than or equal to 50 μm to less than or equal to 150 μm, or more narrowly greater than or equal to 50 μm to less than or equal to 125 μm (e.g., 50 μm to 60 μm, 60 μm to 70 μm, 70 μm to 80 μm, 80 μm to 90 μm, or 90 to 100 μm). The paper layer 50 may have a weight that is greater than or equal to 40 GSM to less than or equal to 120 GSM.

The metallic layer 52 has a third surface 58 and a fourth surface 60 opposite the third surface 58. The metallic layer 52 has a third thickness 61, which may be greater than or equal to 0.01 μm to less than or equal to about 0.05 μm, or more narrowly greater than or equal to 0.2 μm to less than or equal to 0.04 μm. The metallic layer 52 may have a weight that is greater than or equal to 1 GSM to less than or equal to 10 GSM, or more narrowly greater than or equal to 3 GSM to less than or equal to 7 GSM.

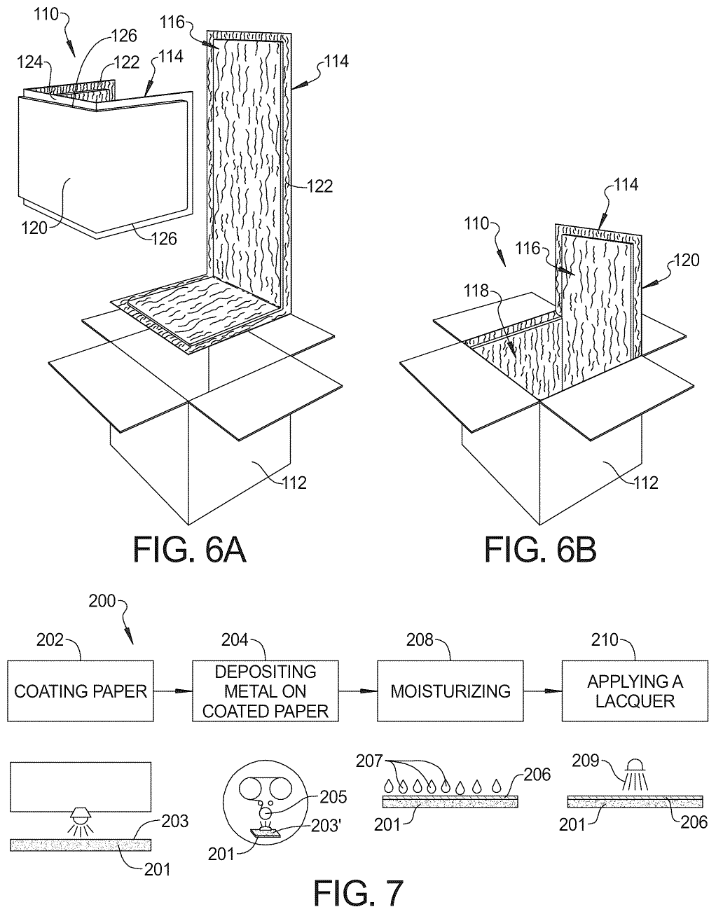

The foil paper 16 may include additional layers such as an adhesive layer between the paper layer 50 and metallic layer 52. An adhesive layer between the paper layer 50 and the metallic layer 52 may have a thickness that is greater than or equal to 1 μm to less than or equal to 5 μm. Additionally or alternatively, the foil paper 16 may include one or more coatings, such as a laquer coating, disposed on the fourth surface 60 of the metallic layer. The one or more coatings may achieve a desired finish of the foil paper 16, such as to make the foil paper 16 smooth and/or glossy in appearance. The first surface 54 of the paper layer 50 is attached to the first surface 40 of the insulation pad 15. The third surface 58 of the metallic layer 52 is attached to the second surface 56 of the paper layer 50 (e.g., via direct metallization and/or transfer metallization processes as will be described in greater detail below in the discussion accompanying FIGS. 5 and 6A-6D).

The paper layer 50 is formed of a repulpable paper. For example, the paper layer 50 is formed of cellulose fibers. The metallic layer 52 is formed of a metal such as aluminum, gold, tin, silver, copper, stainless steel, lead, alloys thereof, and/or combinations thereof. Preferably, the metallic layer 52 is formed of a curbside recyclable metal such as aluminum and/or steel.

In this way, the foil paper 16 is curbside recyclable. The foil paper 16 is superior to conventional foil films, such as mylar-based foil films, because the foil paper 16 includes the repulpable paper layer 50. In one example, the packaging container 12 is a curbside recyclable carboard box and the insulation pad 15 is formed of curbside recyclable materials. In other words, the entire packaging assembly 10 including the foil paper 16 is curbside recyclable. Accordingly, after receiving a temperature-sensitive good delivery, the entire packaging assembly 10 may be subsequently recycled by the user.

It follows that the foil paper 16 is a sustainable packaging solution that achieves desired insulation characteristics. In one example, the foil paper 16 is attached only to the first surface 40 of the insulation pad 15 (i.e., the inner compartment 18 facing surface), and the thermal performance of the insulation liner 14 improves by about 45% as compared to an insulation liner that is free of any foil paper. In another example, the foil paper 16 is attached only to the second surface 42 of the insulation pad 15 (i.e., the packaging container 12 facing surface), and the thermal performance of the insulation liner 14 improves by about 10% as compared to an insulation liner that is free of any foil paper. In yet another example, the foil paper is 16 is attached to both the first surface and second surfaces 40 and 42 of the insulation liner 14, and the thermal performance of the insulation liner 14 improves by about 50% as compared to an insulation liner that is free of any foil paper. Because the foil paper 16 on at least one surface of the insulation liner 14 improves thermal performance, it is possible to utilize insulation liners having a reduced thickness, density, and/or volume, enabling lighter-weight packaging and improved sustainability.

Referring to FIG. 4, another insulation liner 14′ is shown. The insulation liner 14′ may be the same as or similar to the insulation liner 14, except that the insulation liner 14′ includes single piece. The insulation liner 14′ may be a unitary body that is folded into the shape of the packaging container 12. The insulation liner 14′ includes the insulation pad 15 and the foil paper 16 coupled to at least one surface of the insulation pad 15.

Referring to FIG. 5, another insulation liner 14″ is shown. The insulation liner 14″ may be the same as or similar to the insulation liner 14 or insulation liner 14′, except that the insulation liner 14″ includes three pieces. The three pieces of the insulation liner 14″ are joined or fitted together into the shape of the packaging container 12. Each piece of the insulation liner 14″ includes the insulation pad 15 and the foil paper 16 coupled to at least one surface of the insulation pad 15.

Referring now to FIGS. 6A and 6B, another packaging assembly 110 according to the present disclosure is shown. The packaging assembly 110 may be the same as or similar to the packaging assembly 10 of FIGS. 1A, 1B, 2-5 except as otherwise described below. The packaging assembly 110 includes a packaging container 112 and an insulation liner 114. The insulation liner 114 includes an insulation pad (not shown) (see, e.g., insulation pad 15 of FIGS. 1A and 1B) and a foil paper 116.

The insulation pad has a first surface (not shown) (see, e.g., first surface 40 of FIG. 2) and an opposite second surface (not shown) (see, e.g., second surface 42 of FIG. 2). The foil paper 116 is coupled to one or both of the first and second surfaces of the insulation pad. In the example shown in FIGS. 6A and 6B, the foil paper 116 is coupled to the first surface facing an inner compartment 118 (FIG. 6B) of the packaging assembly 110, and a foil-free paper 120 is coupled to the second surface facing the packaging container 112. Alternately, the foil paper 116 may be coupled to both the first and second surfaces of the insulation pad.

The foil paper 116 and the foil-free paper 120 (or two layers of the foil paper 116) are attached to one another to fully encapsulate the insulation pad. In the example shown, an outer edge 122 of the foil paper 116 and an outer edge 124 of the foil-free paper 120 are joined together and sealed around a perimeter 126 of the insulation pad. Fully encapsulating the insulation pad may prevent debris or moisture from degrading the insulation pad. It is contemplated that the foil paper 116 may or may not be directly attached to the first and/or second surfaces of the insulation pad (e.g., via an adhesive) in addition to the joined edges 122 and 124. More generally, the foil paper 116 and the foil-free paper 120 (or two layers of the foil paper 116) may be coupled to the insulation pad without being directly attached to the insulation pad.

To manufacture foil paper (e.g., foil paper 16 of FIGS. 1A, 1B, 2-5 or foil paper 116 of FIGS. 6A and 6B), direct metallization and/or transfer metallization processes may be utilized. With reference to FIG. 7, a method 200 of making foil paper via a direct metallization process (DMP) is shown. The method 200 includes coating a paper substrate 201 at step 202. The coating may improve or enhance adhesion of a metal to the paper substrate 201. The coating may include a varnish coating. For example, a surface 203 of the paper substrate 201 is coated with the varnish coating, forming a coated surface 203′.

The method 200 further includes depositing a metal on the paper substrate 201 at step 204. Specifically, the depositing includes directing a metal source 205 towards the coated surface 203′ of the paper substrate 201 and contacting the coated surface 203′ with metal. Any suitable method of deposition could be utilized, such as spray deposition (e.g., cold spray deposition or thermal spraying), electrochemical deposition, electroless deposition, chemical vapor deposition, sputtering, etc. Optionally, other methods of depositing the metal on the paper substrate 201 may be used such as painting, dip coating, etc. The depositing forms a metallic layer 206 on the paper substrate 201.

The method 200 further includes moisturizing (i.e., applying moisture to) the metallic layer 206 at step 208. For example, the moisturizing may include spraying all or a portion of the metallic layer 206 with a liquid (e.g., water) 207.

Next, the method 200 includes applying a lacquer 209 to the metallic layer 206 at step 210. All or a portion of the metallic layer 206 may be coated with the lacquer 209 to protect the metallic layer 206 from damage. Optionally, after the applying the lacquer 209, the foil paper may be slit or cut to the desired dimensions. After forming the foil paper, the foil paper is coupled to an insulation pad, such as insulation pad 15, to form an insulation liner.

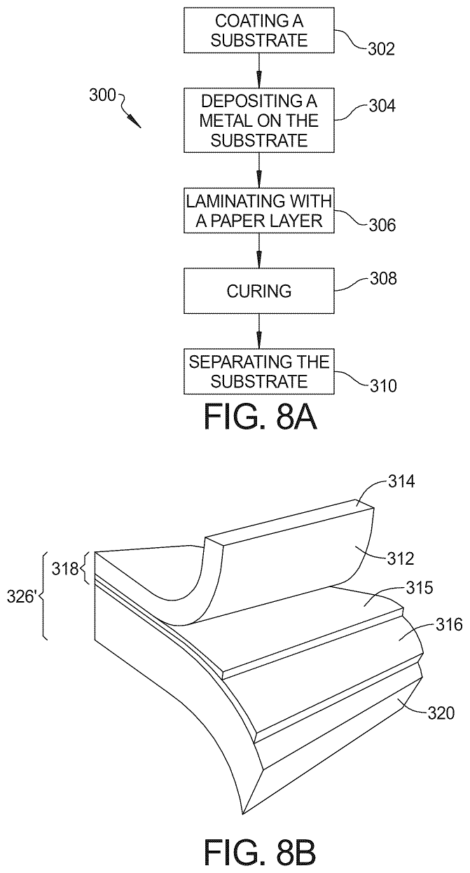

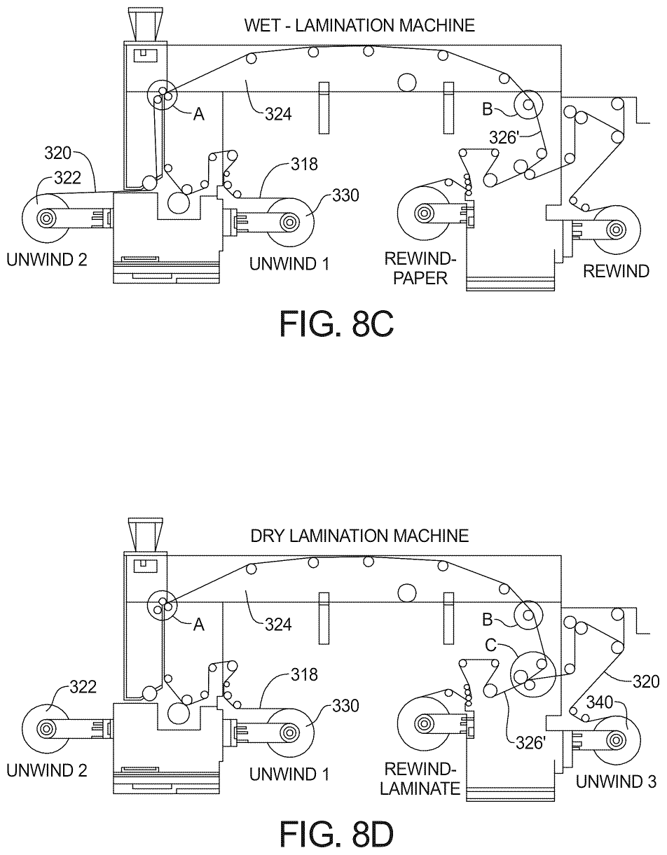

With reference to FIG. 8A through 8D, a method 300 of making foil paper via a transfer metallization process (TMP) is shown. The method generally includes coating a substrate at step 302, depositing a metal on the substrate to form a metal layer at step 304, laminating the substrate with a paper layer to form a paper foil at step 306, curing at step 308, and separating the substrate from the paper foil at step 310.

At step 302, a surface 312 (FIG. 8B) of a substrate 314 is coated with a lacquer 315. The substrate 314 may be a polymer substrate, such as a polyethylene (PET) film. Coating the substrate 314 with the lacquer 315 may enable easy separation of the substrate 314 from the paper foil after fabrication. The lacquer 315 may also protect the metal layer after the substrate 314 is removed.

At step 304, a metal is deposited on the surface 312 of the substrate 314 to form a metallic layer 316. The depositing may include any suitable deposition process. In one example, the depositing includes vacuum deposition. The depositing forms a metal-coated substrate 318.

At step 306, the metal-coated substrate 318 is adhesive-laminated to a paper layer 320. The adhesive-lamination may utilize a laminating fluid such as a water-based fluid or a solvent-based fluid. The laminating may utilize wet lamination (FIG. 8C) or dry lamination (FIG. 8D) processes. As best shown in FIG. 8C, in a wet lamination process, the metal-coated substrate 318 is loaded onto a first unwinder 330 and paper (e.g., to form the paper layer 320) is loaded onto a second unwinder 322. The paper layer 320 is combined with the metal-coated substrate 318 at point A, prior to entering an oven 324 (e.g., a dry hood). In the oven 324, the paper layer 320 adheres to the metal-coated substrate 318 to form a laminated foil paper 326′, which exits the oven 324 at point B.

As best shown in FIG. 8D, in a dry lamination process, the metal-coated substrate 318 is loaded onto the first unwinder 330. The metal-coated substrate 318 enters the oven 324 at point A and exits the oven 324 at point B. In the oven 324, the laminating fluid including water (e.g., in the water-based process) or solvent (e.g., in the solvent-based process) is evaporated from the substrate 318. After exiting the oven 324, paper (e.g., to form the paper layer 320) loaded on a third unwinder 340 is joined with the metal-coated substrate 318 at point C, forming the laminated foil paper 326′.

At step 308, the laminated foil paper 326′ is cured. The curing improves the adhesive bond between the paper layer 320 and the metallic layer 316. The curing may include air curing, UV curing, heat curing, chemical curing, etc. In one example, the laminated foil paper 326′ is cured for about 24 hours.

At step 310, the substrate 314 is separated or removed from the laminated foil paper 326′ to form a foil paper 326. The separating may include peeling, scoring, bursting separation methods, flying knife separation methods, hot knife separation methods, etc. Optionally, after the substrate 314 is separated from the foil paper 326, the foil paper 326 is slit or cut to the desired dimensions. After fabrication, the foil paper 326 is coupled to an insulation pad, such as insulation pad 15, to form an insulation liner.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term “and/or” includes any and all combinations of one or more of the associated listed items. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A packaging insulation liner comprising:
an insulation pad; and
a foil paper coupled to the insulation pad, the foil paper comprising a paper layer and a metallic layer disposed on the paper layer, wherein the foil paper is recyclable.

2. The packaging insulation liner of claim 1, wherein the insulation pad has a first surface and a second surface opposite of the first surface, and the foil paper is attached to the first surface.

3. The packaging insulation liner of claim 2, wherein the foil paper is also attached to the second surface.

4. The packaging insulation liner of claim 2, wherein a foil-free paper is attached to the second surface.

5. The packaging insulation liner of claim 2, wherein a first piece of the foil paper is attached to one of (i) a piece of a foil-free paper or (ii) a second piece of the foil paper to encapsulate the insulation pad.

6. The packaging insulation liner of claim 1, wherein the metallic layer of the foil paper is made of a metal selected from a group consisting of aluminum, gold, tin, silver, copper, steel, lead, alloys thereof, and combinations thereof.

7. The packaging insulation liner of claim 1, wherein the metallic layer of the foil paper is made of a metal selected from a group consisting of aluminum, steel, or combinations thereof.

8. The packaging insulation liner of claim 1, wherein the insulation pad includes a plurality of fibers made from a material selected from a group consisting of thermoplastic, cellulose, and combinations thereof.

9. The packaging insulation liner of claim 8, wherein the plurality of fibers include substrate fibers and binder fibers, the substrate fibers are made of the material selected from the group consisting of thermoplastic, cellulose, and combinations thereof, and the binder fibers are bicomponent fibers made of thermoplastic.

10. A packaging assembly comprising:
the packaging insulation liner of claim 1; and
a packaging container, wherein the insulation liner is disposed within the packaging container.

11. The packaging assembly of claim 10, wherein the packaging container is a cardboard box.

12. A method of forming an insulation liner, the method comprising:
depositing a metal on a paper substrate to form a foil paper; and
coupling the foil paper to an insulation pad.

13. The method of claim 12, further comprising coating the paper substrate with a varnish coating before depositing the metal on the paper substrate.

14. The method of claim 12, further comprising applying a lacquer to the foil paper before coupling the foil paper to the insulation pad.

15. The method of claim 14, further comprising moisturizing the foil paper before applying the lacquer to the foil paper.

16. A method of forming an insulation liner, the method comprising:
depositing a metal on a surface of a substrate to form a metallic layer;
laminating a paper layer onto the metallic layer of the substrate to form a foil paper;
separating the foil paper from the substrate; and
coupling the foil paper to an insulation pad.

17. The method of claim 16, further comprising coating the surface of the substrate with a lacquer coating before depositing the metal on the surface of the substrate.

18. The method of claim 16, wherein the substrate is a polyethylene film.

19. The method of claim 16, further comprising laminating the paper layer onto the metallic layer using a wet lamination process.

20. The method of claim 16, further comprising laminating the paper layer onto the metallic layer using a dry lamination process.
